(19) United States
(12) Patent Application Publication
(10) Pub. No.: US 2018/0114285 A1
(43) Pub. Date: Apr. 26, 2018

(54) COMPUTER IMPLEMENTED METHOD AND SYSTEM FOR CONDITION-BASED COGNITIVE RECIPE PLANNING, FOOD PREPARATION OUTSOURCING AND DELIVERY

(71) Applicant: International Business Machines Corporation, Armonk, NY (US)

(72) Inventors: Anni R. Coden, Bronx, NY (US); Hani T. Jamjoom, Cos Cob, CT (US); David M. Lubensky, Brookfield, CT (US); Justin G. Manweiler, Somers, NY (US); Katherine Vogt, New York, NY (US); Justin D. Weisz, Stamford, CT (US)

(21) Appl. No.: 15/332,490

(22) Filed: Oct. 24, 2016

(51) Int. Cl. G06Q 50/12; G06Q 30/06

(52) U.S. Cl. CPC G06Q 50/12; G06Q 30/0621

(57) ABSTRACT

Systems and methods for storing in a first database a user personal profile, storing in a second database per-restaurant profiles for a plurality of restaurants, enabling the user to connect to a cognitive computer, enabling the user to interact with the cognitive computer for generating a personalized recipe based on user culinary selections and the user profile in the first database, the personalized recipe including a first list of ingredients, determining by the cognitive computer whether there are one or more first type candidate restaurants for preparing the personalized recipe based on the per-restaurant profiles in the second database, the first type candidate restaurant being determined to be able to prepare the personalized recipe with the first list of ingredients, receiving a selection of a selected restaurant from the first type candidate restaurant and contracting out the preparation of the personalized recipe to the selected restaurant.

### FIELD

The present application relates generally to computers, and computer applications, and more particularly to computer-implemented methods to plan recipes and prepare food.

### BACKGROUND

Ordering a prepared meal from a nearby restaurant does not take into account several factors of personalization, including specific ingredients, for a specific consumer.

Also, typical ordering of a prepared meal does not include interaction with two or more candidate restaurants that are capable of preparing the proposed meal. Further, typical decisions for ordering of prepared meals are not based on previous availability of specific ingredients from previous orders.

This typical method of ordering prepared meals is not as effective as it could be and does not include decision making capabilities based on several inputs and consideration of two or more restaurants capable of providing the prepared meal.

### BRIEF SUMMARY

In one embodiment, a computer implemented method for generating a personalized recipe includes storing in a first database a user personal profile, storing in a second database per-restaurant profiles for a plurality of restaurants, enabling the user to connect to a cognitive computer, enabling the user to interact with the cognitive computer for generating a personalized recipe based on user culinary selections and the user profile in the first database, the personalized recipe including a first list of ingredients, determining by the cognitive computer whether there are one or more first type candidate restaurants for preparing the personalized recipe based on the per-restaurant profiles in the second database, the first type candidate restaurant being determined to be able to prepare the personalized recipe with the first list of ingredients, receiving a selection of a selected restaurant from the first type candidate restaurant and contracting out the preparation of the personalized recipe to the selected restaurant.

A system that includes one or more processors operable to perform one or more methods described herein also may be provided.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is an overall system diagram of a system environment running methods described herein.

FIG. 2 is a flowchart including several steps of the disclosed method.

FIG. 3 is a flowchart including several steps of the disclosed method

FIG. 4 depicts a cloud computing environment according to an embodiment of the present invention.

FIG. 5 depicts abstraction model layers according to an embodiment of the present invention.

FIG. 6 illustrates a schematic of an example computer or processing system according to an embodiment of the present disclosure.

### DETAILED DESCRIPTION

The disclosure is directed to a computer system and a computer-implemented method for generating a personalized recipe. One embodiment includes storing a personal diet profile for a user, determining a personalized recipe for the user and then determining which restaurant to order that meal from. As used herein the term “recipe” can include one or more ingredients and one or more dishes (such as salad, side dish, main dish, etc.). For example, one “recipe” could be a single ingredient (ice cream) for a single dish (dessert). As another example, the term “recipe” can include a plurality of ingredients for a meal of salad (including lettuce, cucumbers, etc.) and spaghetti and meatballs (including pasta, meat, bread crumbs, etc.)) for two dishes: salad; and a main dish.

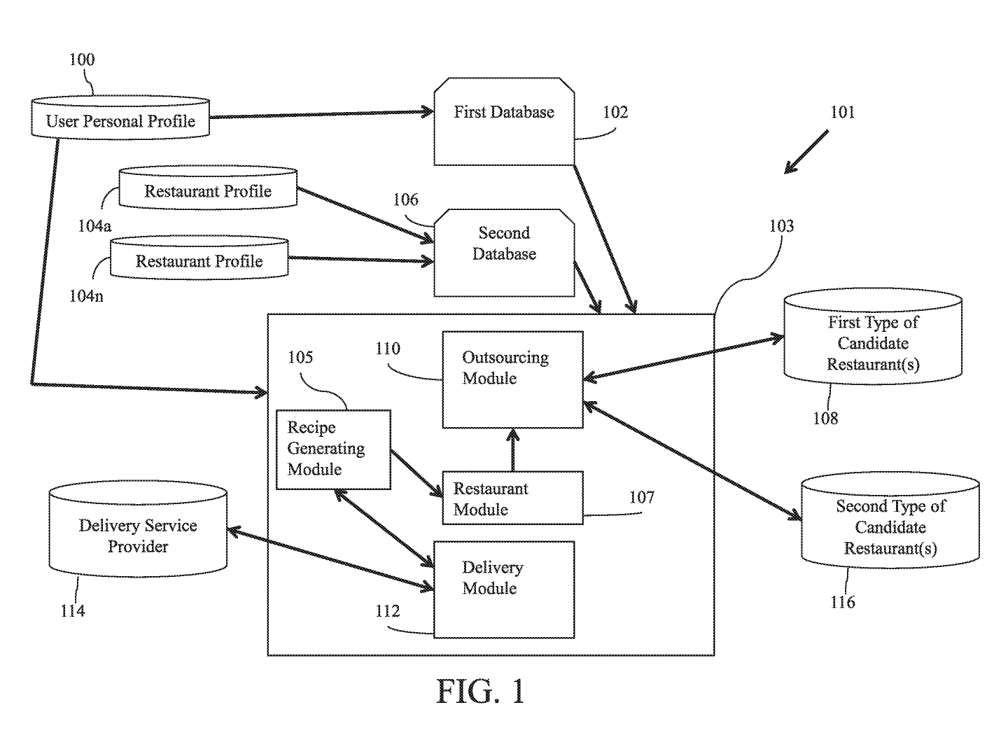

FIG. 1 depicts a computer system 101 that provides a method for generating a personalized recipe. In particular, FIG. 1 illustrates the receipt, from a user computer, tablet, mobile phone or other user computing device 100, a user personal profile by a first database 102, which stores the user personal profile. Also illustrated is the receipt, from a plurality of restaurant computers, tablets, mobile phones or other restaurant computing devices 104a-104n, a plurality of restaurant profiles by a second database 106 which stores the restaurant profiles. Included as part of the computer system is a cognitive computer 103 having one or more processors, and including a recipe generating module 105, an outsourcing module 110 and a delivery module 112. The recipe generating module 105 enables the user to interact with the cognitive computer 103 to input user culinary selections. The recipe generating module 105 generates a personalized recipe based on the user culinary selections, the user profile and the restaurant profile.

The outsourcing module 110 can receive and transmit with a first type of candidate restaurants 108, and optionally a second type of candidate restaurants 116. The delivery module 112 can receive and/or transmit the personalized recipe to a delivery service provider 114. An exemplary flow diagram of the system is shown in the figures discussed below.

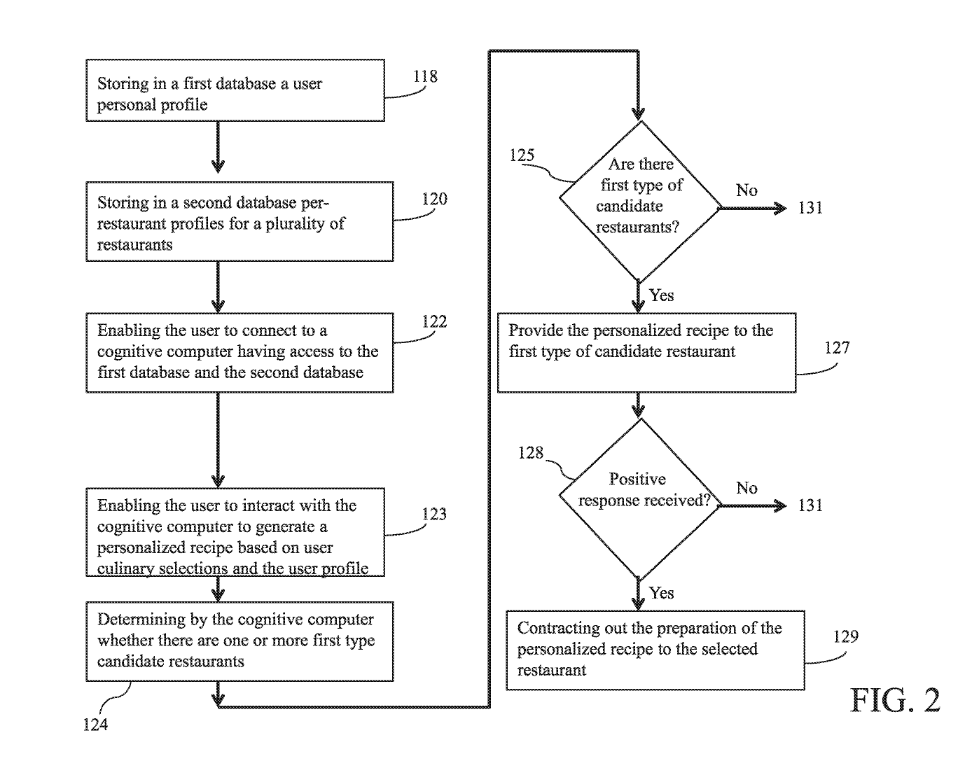

To generate a personalized recipe, the computer system 101, as shown in FIG. 2, stores a received input of the user personal profile in the first database 102 in step 118. The user personal profile can include one or more of the following: dietary requirements of the user, user culinary preferences, user medical conditions and user location information. The user personal profile can also include the user's name or other identifying information and a user's location information.

Any of the user personal profile information can be changed at any time, such as user personal profile can be updated to include a changed location information (such as if the user moves from one residence to another, or if the user is located at work instead of being located at home). As another example user personal profile can be updated to change the medical condition of the user if the user's high blood pressure value decreases.

The dietary requirements of the user that can be included in the user personal profile can include, for example, high protein requirements, kosher requirements, halal requirements, vegan requirements, animal product requirements (such as vegetarian requirements), lactose level requirements (including lactose-free requirements), allergies, nut requirements (such as peanut and other tree nut requirements) and oil requirements.

User culinary preferences of the user personal profile can include, for example, preference of spice level, preference of cooking level (e.g. rare, medium, well done, etc.), preference of style of cooking (e.g. Vietnamese, Italian, Sushi, etc.) and preference of salt level.

User medical conditions of the user personal profile can include, for example, coronary heart disease, high blood pressure, diabetes and various heart conditions.

After storage of the user personal profile the method stores received restaurant profiles, for a plurality of restaurants, in a second database 106 in step 120. The restaurant profiles, for each of the plurality of restaurants, can include one or more of the following: type of cuisine of the restaurant, recipe ingredients of the restaurant, location information of the restaurant and reputation of the restaurant.

The type of cuisines of the restaurants that can be included in the restaurant profiles can include, for example, Vietnamese, Italian, Sushi, etc.

The recipe ingredients of the restaurants that can be included in the restaurant profiles can include information about the availability of any number of different ingredients present in the restaurant based on publication of that information by the restaurant or previous recipes supplied by the restaurant to the user. For example, if the user has a recipe provided from Restaurant A that includes basil and pasta, the restaurant profile 104a can be updated to indicate that basil and pasta are available ingredients at the restaurant.

The location information of the restaurants that can be included in the restaurant profiles can include, for example, radial straight-line distance and estimated driving time between the restaurant's location and the user.

The reputation of the restaurants that can be included in the restaurant profiles can include, for example, reputation from third party commenters (e.g. through Yelp®) and/or through previous reputation indications from the user.

After step 120, the user is enabled to connect to the cognitive comp 103, which has access to the first database 102 and the second database 106 in step 122.

Then, in step 123, the user is enabled to interact with the cognitive computer 103 to generate a personalized recipe that is based on both a culinary selection (for example, the user selects a main dish of grilled beef steak with a side dish of mashed potatoes) and the user profile stored in the first database 102. Based on the specific culinary selection, and the user profile, which includes, for example a dietary requirement (lactose-free requirement), a culinary preference (medium rare cooking), medical condition (high blood pressure), a personalized recipe is generated that includes a first list of ingredients.

The first list of ingredients of the personalized recipe that is generated includes the culinary selection and also the requirements of the user profile. In this example, no lactose including ingredients are included (dietary requirement), the beef steak is to be prepared medium rare (culinary preference) and no additional salt is to be added (medical condition). Therefore, an example first list of ingredients is beef steak, potatoes and seasonings (other than salt).

Then, in step 124, a restaurant module 107 determines whether there are one or more of a first type of candidate restaurants that can prepare the personalized recipe based on the restaurant profiles stored in the second database 106. The first type of candidate restaurants can be those with restaurant profiles that include the cuisine of the personalized recipe, the recipe ingredients of the personalized recipe and have a location within a certain distance. To identify the first type of candidate restaurants 108, thresholds can be provided for each element of the restaurant profile. For example, the distance between the user and the restaurant's location can have a threshold value of less than ten miles.

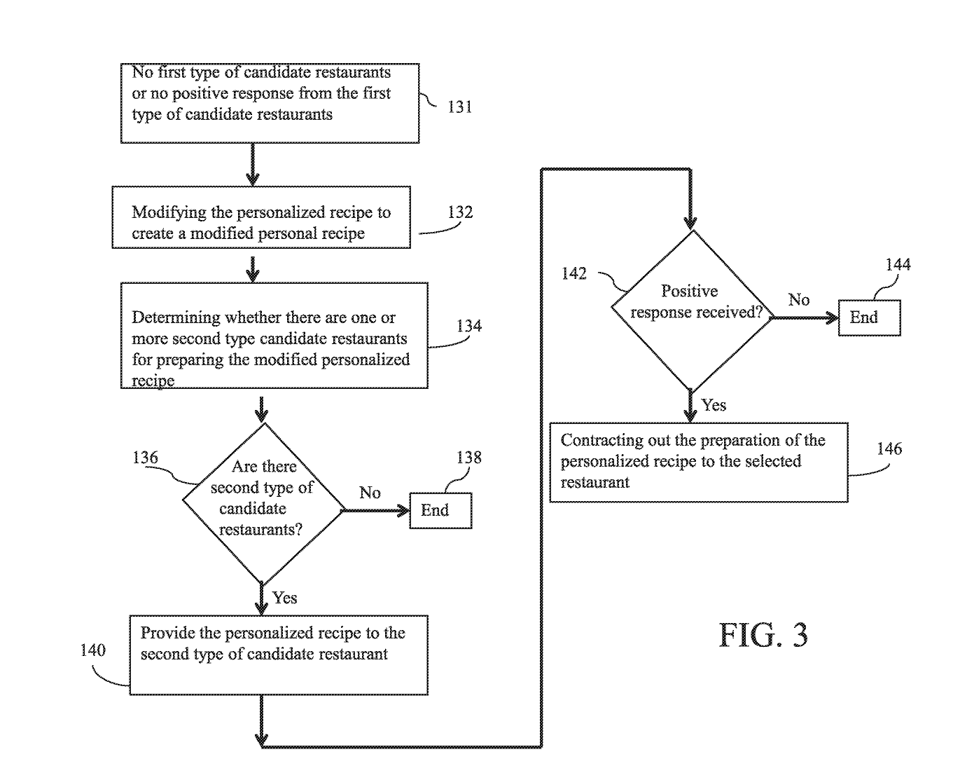

If the restaurant module 107 determines that there are multiple first type of candidate restaurants in step 125, the first type of candidate restaurants can be ranked based on, for example, nearness in location, the percentage of recipe ingredients the restaurant has and the cuisine type the restaurant has. If the restaurant module 107 determines that there are no first type of candidate restaurants in step 125, the method can progress to step 131 discussed below in reference to FIG. 3.

After the first type of candidate restaurants are determined by the restaurant module 107, an outsourcing module 110 of the restaurant module 107 contacts each of the first type of candidate restaurants 108 and provides the personalized recipe and the location of the user in step 127.

Along with contacting each of the first type of candidate restaurants 108, the outsourcing module 110 can also provide a historical price range of recipes that have been accepted by the user for the same or a similar personalized recipe. For example, for the same personalized recipe “R”, a history of recipes accepted by the user, along with their associated prices “P”, is provided as (R, P), (R, P1), (R1, P2), (R2, P3), etc. with R1 and R2 being different from personalized recipe “R” by at least one ingredient. Along with providing the price and recipe data, outsourcing module 110 can perform a function that determines the similarity between recipe R and R1, R2, etc., so that previous personalized recipes selected by the user are within a range of similarity to the current personalized recipe and their associated prices can be more closely compared to the current personalized recipe. Also optionally, the outsourcing module 110 can provide an average price for all previously selected recipes “R” and “R1”, “R2” etc. within a similarity threshold.

After providing the personalized recipe and the location of the user to each of the first type of candidate restaurants 108, the outsourcing module 110 waits a predetermined amount of time for a response from each of the first type of candidate restaurants 108.

If no responses are received by the outsourcing module 110 from the first type of candidate restaurants 108 within the predetermined amount of time, the restaurant module 107 can again determine a new group of candidate restaurants that excludes the first type of candidate restaurants 108 and wait for responses from them. This process can continue several times with the restaurant module 107 determining successive groups of candidate restaurants a predetermined amount of times. If after the predetermined amount of times no candidate restaurants at all respond to the outsourcing module 110, the restaurant module 107 can alert the user that the personalized recipe cannot be provided and can prompt the user to make a selection of a different personalized recipe. In another embodiment, in step 128, if not positive responses are received, the method can proceed with step 131 discussed in reference to FIG. 3.

If at least one of the first type of candidate restaurants 108 can fulfill the personalized recipe, after the candidate restaurants are provided with the personalized recipe and the location of the user, each of the at least one first type of candidate restaurants 108 can respond to the outsourcing module 110 within the predetermined time in step 128. The response received from one or more of the first type of candidate restaurants 108 received by the outsourcing module 110, can be a notification that the responding restaurant is capable of creating the personalized recipe, they are capable of delivering the personalized recipe to the user's location and what the price associated with preparation or preparation and delivery is.

The outsourcing module 110 can then receive a selection of the candidate restaurant in one of two ways. The first way the outsourcing module 110 can receive the selection is by presenting a list of the first type of candidate restaurants 108, along with associated prices for creating the personalized recipe to the user so that the user can select the candidate restaurant in step 128. The second way the outsourcing module 110 can receive the selection is for the outsourcing module 110 itself to be configured to automatically select the first type of candidate restaurant 108 (or second type of candidate restaurants 116) with one of the lowest associated cost and the lowest time for delivery in step 128.

Each response received by the outsourcing module 110 from the first type of candidate restaurants 108 can be stored in the second database 106 for reference when the user selects another recipe in the future. Specifically, the availability of certain ingredients in the recipe can be stored in the second database 106 for review by the cognitive computer 103 when the user selects a future recipe.

Once a candidate restaurant is selected, from the first type of candidate restaurant 108 or a subsequent candidate restaurant (such as the second type of candidate restaurants 116), the selected candidate restaurant is notified that they are selected and they are contracted out to prepare the personalized recipe in step 129, with the user's payment information also being provided.

In another embodiment, the method progresses to step 131 of FIG. 3. If there are no first type of candidate restaurants or a positive response from the first type of candidate restaurants is not received, in FIG. 3 the recipe generating module 105 of restaurant module 107 can automatically modify the personalized recipe and create a second list of ingredients for the modified personalized recipe in step 132. This second list of ingredients has at least one ingredient that is different than the first list of ingredients. The modified personalized recipe is different than the original personalized recipe, but still meets the requirements of the user profile stored in the first database 102. The restaurant module 107 can include information regarding similarity in taste between ingredients and choose the at least one different ingredient for the second list of ingredients that has a similar taste to the ingredient in the first list of ingredients.

As an example of this, in view of the example provided above, the restaurant module 107 modifies the user's selection of a main dish of grilled beef steak with a side dish of mashed potatoes to a main dish of grilled buffalo steak with a side dish of mashed potatoes. Based on this specific culinary selection, and the user profile, which includes, for example a dietary requirement (lactose-free requirement), a culinary preference (medium rare cooking), medical condition (high blood pressure), a modified personalized recipe is generated that includes a second list of ingredients.

The second list of ingredients of the modified personalized recipe that is generated includes the culinary selection and also the requirements of the user profile. In this example, no lactose including ingredients are included (dietary requirement), the buffalo steak is to be prepared medium rare (culinary preference) and no additional salt is to be added (medical condition). Therefore, an example second list of ingredients is buffalo steak, potatoes and seasonings (other than salt).

Then the restaurant module 107 determines whether there are one or more of a second type of candidate restaurants 116 that can prepare the modified personalized recipe based on the restaurant profiles stored in the second database 106 in step 134. The second type of candidate restaurants 116 can be those with restaurant profiles that include the cuisine of the modified personalized recipe, the recipe ingredients of the modified personalized recipe and have a location within a certain distance. To identify the second type of candidate restaurants 116, thresholds (which can be the same or different from the thresholds of the first type of candidate restaurants 108) can be provided for each element of the restaurant profile. For example, the distance between the user and the restaurant's location can have a threshold value of less than twenty miles.

If there are no second type of candidate restaurants 116, in step 136 the method ends at step 138. If there are second type of candidate restaurants 116, in step 136, the second type of candidate restaurants 116 can be ranked based on, for example, nearness in location, the percentage of recipe ingredients the restaurant has and the cuisine type the restaurant has.

After the second type of candidate restaurants 116 are determined by the restaurant module 107, an outsourcing module 110 of the cognitive computer 103 contacts each of the second type of candidate restaurants 116 and provides the modified personalized recipe and the location of the user in step 140.

After providing the modified personalized recipe and the location of the user to each of the second type of candidate restaurants 116, the outsourcing module 110 waits a predetermined amount of time for a response from each of the second type of candidate restaurants 116. If no response is received from any of the second type of candidate restaurants 116 in step 142, the method ends at step 144. The cognitive computer 103 can alert the user that no second type of candidate restaurant has been found and the user can modify the personalized recipe or end the process.

If at least one of the second type of candidate restaurants 116 can fulfill the modified personalized recipe, each of the at least one second type of candidate restaurants 116 can respond to the outsourcing module 110 within the predetermined time in step 142. The response received from one or more of the second type of candidate restaurants 116 received by the outsourcing module 110 in step 142, can be a notification that the responding restaurant is capable of creating the personalized recipe, they are capable of delivering the personalized recipe to the user's location and what the price associated with preparation or preparation and delivery is.

The outsourcing module 110 can then receive a selection of the candidate restaurant in either of the two ways discussed above. Each response received by the outsourcing module 110 from the second type of candidate restaurants 116 can be stored in the second database 106 for reference when the user selects another recipe in the future. Specifically, the availability of certain ingredients in the recipe can be stored in the second database 106 for review by the cognitive computer 103 when the user selects a future recipe.

Once a candidate restaurant is selected, from the second type of candidate restaurants 116, the selected candidate restaurant is notified that they are selected and they are contracted out to prepare the personalized recipe in step 146, with the user's payment information also being provided.

Optionally, if a candidate restaurant is not selected, from the first type of candidate restaurant 108 or a subsequent candidate restaurant, they can be notified that they have not been selected. Also optionally, the candidate restaurant not selected can receive feedback along with the notification, which could include the price of the personalized recipe selected by the user and/or the name of the candidate restaurant selected by the user.

After being contracted to prepare the personalized recipe in step 129 or step 146, the selected candidate restaurant then prepares the personalized recipe and either readies the prepared personalized recipe for pick up by the user or delivers the personalized recipe to the user. Optionally the cognitive computer 103 can include a delivery module 112 that can contact a third party delivery service provider 114 for delivery from the selected candidate restaurant to the user's location. Delivery module 112 can contact one or more delivery service providers 114 (e.g. Uber®) that are capable of delivering the prepared personalized recipe from the selected candidate restaurant to the user's location. The one or more delivery service providers 114 can then respond to the delivery module 112 with a price for delivery service. The delivery module 112 can alert the user to the provided prices, from which the user can select one of the one or more delivery services. The user's payment information stored in first database 102 can then be forwarded from delivery module 112 to the selected delivery service provider.

Once the personalized recipe is received by the user, the user can then provide feedback, through the cognitive computer 103 to the candidate selected candidate restaurant directly or to a third party (e.g. Yelp®), rating the quality of the personalized recipe.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (Paas): the capability provided to the consumer is to deploy onto the cloud infrastructure consumer-created or acquired applications created using programming languages and tools supported by the provider. The consumer does riot manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure that includes a network of interconnected nodes.

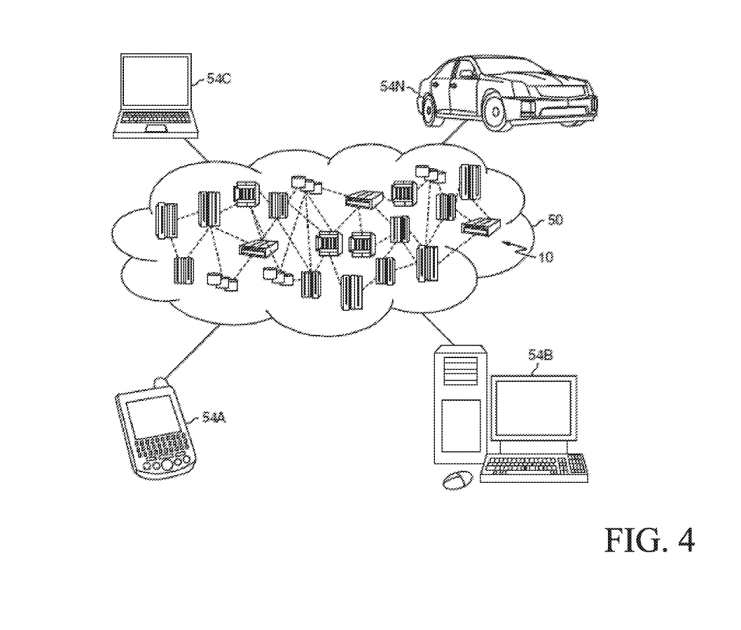

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

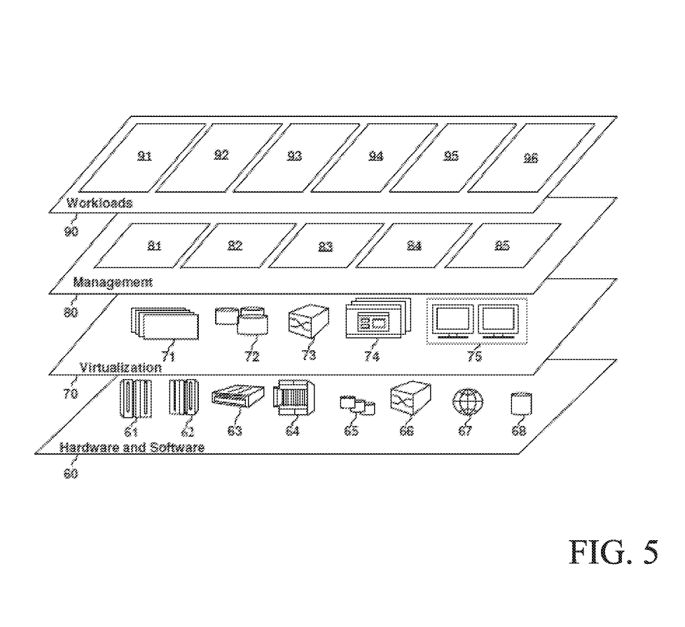

Referring now to FIG. 5, an exemplary set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and generating a personalized recipe 96.

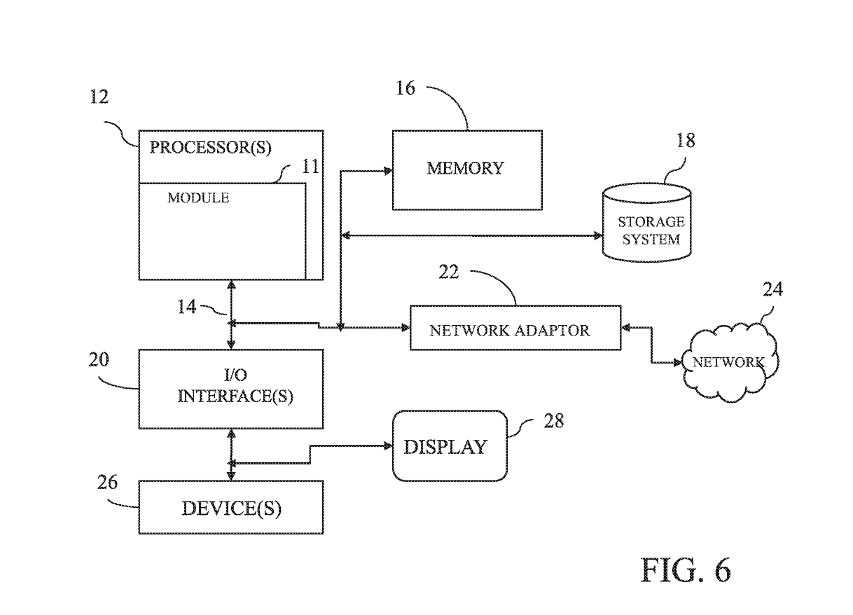

FIG. 6 illustrates a schematic of an example computer or processing system that may implement the method for generating a personalized recipe in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 6 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 11 that performs the methods described herein. The module 11 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order rioted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

In addition, while preferred embodiments of the present invention have been described using specific terms, such description is for illustrative purposes only, and it is to be understood that changes and variations may be made without departing from the spirit or scope of the following claims.

1. A computer implemented method for automatically modifying a personalized recipe based on restaurant profiles stored in a database comprising the steps of:
storing in a first database a user personal profile, the user personal profile comprising one or more of user dietary requirements, user culinary preferences, user medical conditions and user location information;
storing in a second database per-restaurant profiles for a plurality of restaurants, each per-restaurant profile comprising one or more of types of cuisines, recipe ingredients, location information and reputation wherein a cognitive computer has access to the first database and the second database;
generating by the cognitive computer a first personalized recipe based on user culinary selections and the user profile in the first database, the first personalized recipe comprising a first list of ingredients;
determining by the cognitive computer whether there are one or more first type candidate restaurants that are able to prepare the first personalized recipe based on the per-restaurant profiles in the second database, the first type candidate restaurant being determined to be able to prepare the first personalized recipe based on the first list of ingredients;
determining by the cognitive computer that no first type candidate restaurants are able to prepare the personalized recipe;
automatically modifying the personalized recipe, based on the determination by the cognitive computer that there is no first type candidate restaurant able to prepare the personalized recipe, to create a first modified personalized recipe having at least one ingredient different from the ingredients in the first list of ingredients, the cognitive computer providing the first modified personalized recipe that meets the user profile and have similar taste to the first personalized recipe, prior to the step of receiving a selection;
providing by the cognitive computer a historical price range of recipes that have been accepted by the user for the first modified personalized recipe and for at least one second modified personalized recipe, the at least one second modified personalized recipe having at least one ingredient different from the ingredients in the first list of ingredients;
determining by the cognitive computer a similarity between the first modified personalized recipe and the at least one second modified personalized recipe;
automatically selecting by the cognitive computer one or more of the first modified personalized recipe and the at least one second modified personalized recipe that are within a range of similarity to the personalized recipe;
determining by the cognitive computer whether there are one or more second type candidate restaurants that are able to prepare the selected one or more of the first modified personalized recipe and the at least one second modified personalized recipe based on the per-restaurant profiles in the second database;
automatically selecting one of the second type candidate restaurants based on the similarity; and
contracting out the preparation of the personalized recipe to the selected restaurant.

2. The computer implemented method of claim 1, further comprising the steps of
presenting the first candidate restaurant type to the user for selection prior to receiving the selection, and wherein the selection of a selected restaurant is received from the user.

3. (canceled)

4. The computer implemented method of claim 1, wherein the cognitive computer provides a historical price range of the personalized recipe to the first type of candidate restaurants.

5. The computer implemented method of claim 1, wherein the cognitive computer provides a historical price range of the personalized recipe and/or a similar personalized recipe to the first type of candidate restaurants.

6. The computer implemented method of claim 1, wherein the cognitive computer provides an average price for one or more previously selected personalized recipes within a recipe similarity threshold.

7. The computer implemented method of claim 1, further comprising a step of contacting a third party delivery service provider for delivery from the selected restaurant to the user.

8. The computer implemented method of claim 1, wherein software is provided as a service in a cloud environment.

9. A system for automatically modifying a personalized recipe based on restaurant profiles stored in a database, comprising:
one or more storage devices;
one or more hardware processors coupled to the one or more storage devices;
one or more hardware processors operable to store in a first database a user personal profile, the user personal profile comprising one or more of user dietary requirements, user culinary preferences, user medical conditions and user location information;
one or more hardware processors operable to store in a second database per-restaurant profiles for a plurality of restaurants, each per-restaurant profile comprising one or more of types of cuisines, recipe ingredients, location information and reputation wherein a cognitive computer has access to the first database and the second database;
one or more hardware processors operable to generate by the cognitive computer a first personalized recipe based on user culinary selections and the user profile in the first database, the first personalized recipe comprising a first list of ingredients;
one or more hardware processors operable to determine by the cognitive computer whether there are one or more first type candidate restaurants that are able to prepare the first personalized recipe based on the per-restaurant profiles in the second database, the first type candidate restaurant being determined to be able to prepare the first personalized recipe based on the first list of ingredients;
one or more hardware processors operable to determine by the cognitive computer that no first type candidate restaurants are able to prepare the personalized recipe;
one or more hardware processors configured to automatically modify the personalized recipe, based on the determination by the cognitive computer that there is no first type candidate restaurant able to prepare the personalized recipe, to create a first modified personalized recipe having at least one ingredient different from the ingredients in the first list of ingredients, the cognitive computer providing the first modified personalized recipe that meets the user profile and have similar taste to the first personalized recipe, prior to the step of receiving a selection;
one or more hardware processors configured to provide by the cognitive computer a historical price range of recipes that have been accepted by the user for the first modified personalized recipe and for at least one second modified personalized recipe, the at least one second modified personalized recipe having at least one ingredient different from the ingredients in the first list of ingredients;
one or more hardware processors configured to determine by the cognitive computer a similarity between the first modified personalized recipe and the at least one second modified personalized recipe;
one or more hardware processors configured to automatically select by the cognitive computer one or more of the first modified personalized recipe and the at least one second modified personalized recipe that are within a range of similarity to the personalized recipe;
one or more hardware processors configured to determine by the cognitive computer whether there are one or more second type candidate restaurants that are able to prepare the selected one or more of the first modified personalized recipe and the at least one second modified personalized recipe based on the per-restaurant profiles in the second database;
one or more hardware processors operable to automatically select one of the second type candidate restaurants based on the similarity; and
one or more hardware processors operable to contract out the preparation of the personalized recipe to the selected restaurant.

10. The system of claim 9, wherein the system further comprises one or more hardware processors operable to present the first candidate restaurant type to the user for selection prior to receiving the selection, and wherein the selection of a selected restaurant is received from the user.

11. (canceled)

12. The system of claim 9, wherein the cognitive computer provides a historical price range of the personalized recipe to the first type of candidate restaurants.

13. The system of claim 9, wherein the cognitive computer provides a historical price range of the personalized recipe and/or a similar personalized recipe to the first type of candidate restaurants.

14. The system of claim 9, wherein the cognitive computer provides an average price for one or more previously selected personalized recipes within a recipe similarity threshold.

15. The system of claim 9, wherein the system further comprises one or more hardware processors configured to contact a third party delivery service provider for delivery from the selected restaurant to the user.

16. A computer readable storage medium storing a program of instructions executable by a machine to perform a method for automatically modifying a personalized recipe based on restaurant profiles stored in a database, the method comprising:
storing in a first database a user personal profile, the user personal profile comprising one or more of user dietary requirements, user culinary preferences, user medical conditions and user location information;
storing in a second database per-restaurant profiles for a plurality of restaurants, each per-restaurant profile comprising one or more of types of cuisines, recipe ingredients, location information and reputation wherein a cognitive computer has access to the first database and the second database;
generating by the cognitive computer a first personalized recipe based on user culinary selections and the user profile in the first database, the first personalized recipe comprising a first list of ingredients;
determining by the cognitive computer whether there are one or more first type candidate restaurants that are able to prepare the first personalized recipe based on the per-restaurant profiles in the second database, the first type candidate restaurant being determined to be able to prepare the first personalized recipe based on the first list of ingredients;
determining by the cognitive computer that no first type candidate restaurants are able to prepare the personalized recipe;
automatically modifying the personalized recipe, based on the determination by the cognitive computer that there is no first type candidate restaurant able to prepare the personalized recipe, to create a first modified personalized recipe having at least one ingredient different from the ingredients in the first list of ingredients, the cognitive computer providing the first modified personalized recipe that meets the user profile and have similar taste to the first personalized recipe, prior to the step of receiving a selection;
providing by the cognitive computer a historical price range of recipes that have been accepted by the user for the first modified personalized recipe and for at least one second modified personalized recipe, the at least one second modified personalized recipe having at least one ingredient different from the ingredients in the first list of ingredients;
determining by the cognitive computer a similarity between the first modified personalized recipe and the at least one second modified personalized recipe;
automatically selecting by the cognitive computer one or more of the first modified personalized recipe and the at least one second modified personalized recipe that are within a range of similarity to the personalized recipe;
determining by the cognitive computer whether there are one or more second type candidate restaurants that are able to prepare the selected one or more of the first modified personalized recipe and the at least one second modified personalized recipe based on the per-restaurant profiles in the second database;
automatically selecting one of the second type candidate restaurants based on the similarity; and
contracting out the preparation of the personalized recipe to the selected restaurant.

17. The computer readable storage medium of claim 16, wherein the method further comprises the steps of:
presenting the first candidate restaurant type to the user for selection prior to receiving the selection, and wherein the selection of a selected restaurant is received from the user.

18. (canceled)

19. The computer readable storage medium of claim 16, wherein the cognitive computer provides a historical price range of the personalized recipe to the first type of candidate restaurants.

20. The computer readable storage medium of claim 16, wherein the cognitive computer provides a historical price range of the personalized recipe and/or a similar personalized recipe to the first type of candidate restaurants.

21. The computer implemented method of claim 1, further comprising a step of notifying the one or more unselected restaurants of one or more notifications selected from the group consisting of a notification that the one or more unselected restaurants has not been selected to prepare the modified personalized recipe, a notification of a price of the personalized recipe of the selected restaurant and a notification of a name of the selected restaurant.

22. The system of claim 9, wherein the system further comprises one or more hardware processors operable to notify the one or more unselected restaurants of one or more notifications selected from the group consisting of a notification that the one or more unselected restaurants has not been selected to prepare the modified personalized recipe, a notification of a price of the personalized recipe of the selected restaurant and a notification of a name of the selected restaurant.

23. The computer readable storage medium of claim 16, notifying the one or more unselected restaurants of one or more notifications selected from the group consisting of a notification that the one or more unselected restaurants has not been selected to prepare the modified personalized recipe, a notification of a price of the personalized recipe of the selected restaurant and a notification of a name of the selected restaurant.
